(19) United States
(12) Patent Application Publication
(10) Pub. No.: US 2025/0304184 A1
(43) Pub. Date: Oct. 2, 2025

(54) VEHICLE FRONT STRUCTURE

(71) Applicant: TOYOTA JIDOSHA KABUSHIKI KAISHA, Toyota-shi (JP)

(72) Inventor: Koji SAEKI, Okazaki-shi (JP)

(73) Assignee: TOYOTA JIDOSHA KABUSHIKI KAISHA, Toyota-shi (JP)

(21) Appl. No.: 19/013,294

(22) Filed: Jan. 8, 2025

(30) Foreign Application Priority Data
Mar. 27, 2024 (JP) 2024-052495

(51) Int. Cl. B62D 25/08; B62D 21/15

(52) U.S. Cl. CPC B62D 25/088; B62D 21/152

(57) ABSTRACT

The vehicle front structure includes a pair of front side members provided on both side portions in the vehicle width direction in the vehicle front portion and extending in the vehicle front-rear direction, a suspension member disposed on the vehicle lower side of the front side member, a joint portion for joining the front side member and the suspension member, and a protruding portion provided in the joint portion and protruding outward in the vehicle width direction.

### CROSS-REFERENCE TO RELATED APPLICATION

This application claims priority to Japanese Patent Application No. 2024-052495 filed on Mar. 27, 2024, incorporated herein by reference in its entirety.

### BACKGROUND

### 1. Technical Field

The present disclosure relates to a vehicle front structure.

### 2. Description of Related Art

Japanese Unexamined Patent Application Publication No. 2013-233820 (JP 2013-233820 A) discloses a vehicle front structure in which an expansion member extending outward in a vehicle width direction is provided at a position of a front end of a suspension member and an end in the vehicle width direction. In this vehicle front structure, the expansion member receives a collision body (barrier) via a bumper reinforcement at the time of small overlap collision, thereby generating a lateral force to a side opposite to the collision side in the vehicle and reducing the amount of entry of the collision body. That is, in the vehicle front structure of JP 2013-233820 A, a collision load is input to the expansion member of the suspension member via the bumper reinforcement. At this time, an outward reaction force in the vehicle width direction is generated at a contact portion between the bumper reinforcement and the expansion member. Therefore, this reaction force is used as the lateral force for releasing the vehicle from the collision body.

### SUMMARY

In this vehicle front structure, however, the reaction force acting on the contact portion between the bumper reinforcement and the suspension member greatly depends on the bending rigidity of the suspension member in the vehicle width direction. Therefore, the above related art has room for improvement to efficiently release the vehicle from the collision body at the time of small overlap collision of the vehicle.

The present disclosure provides a vehicle front structure capable of efficiently releasing a vehicle from a collision body at the time of small overlap collision of the vehicle.

A vehicle front structure according to a first aspect includes:
a pair of framework portions extending in a vehicle front-rear direction, the framework portions being each provided on a side of a vehicle front portion in a vehicle width direction and;
a suspension member disposed on a vehicle lower side of the framework portions;
a joint portion that joins the framework portion and the suspension member; and
a protruding portion provided at the joint portion and protruding to an outer side in the vehicle width direction.

In the vehicle front structure according to the first aspect, on both sides in the vehicle width direction, the protruding portions are provided at the joint portions that join the framework portions extending in the vehicle front-rear direction and the suspension member disposed on the vehicle lower side of the framework portions. The protruding portion protrudes to the outer side in the vehicle width direction from the joint portion. Therefore, when a collision load to the vehicle rear side is mainly input to the protruding portion at the time of small overlap collision between the vehicle and a collision body, a component force of the collision load to an inner side in the vehicle width direction is efficiently distributed to the framework portion and the suspension member via the joint portion. Thus, the reaction force at the contact portion between the collision body and the protruding portion is generated by the bending rigidity of the framework portion and the suspension member in the vehicle width direction. Accordingly, the reaction force acting on the contact portion can be improved, and the vehicle can be efficiently released from the collision body at the time of small overlap collision of the vehicle.

In the vehicle front structure according to the first aspect, an inclined portion that is inclined to a vehicle rear side and the outer side in the vehicle width direction in a plan view is provided at an end of the protruding portion on the outer side in the vehicle width direction.

In the vehicle front structure according to the above aspect, at the time of small overlap collision between the vehicle and the collision body, the inclined portion provided at the end of the protruding portion on the outer side in the vehicle width direction can change the collision load mainly to the vehicle rear side into a lateral force to the inner side in the vehicle width direction. Accordingly, the component force of the collision load to the inner side in the vehicle width direction can be efficiently transmitted to the framework portion and the suspension member.

In the vehicle front structure according to the first aspect, in a region on a vehicle front side including the protruding portion, the end of the protruding portion on the outer side in the vehicle width direction is positioned on the outer side in the vehicle width direction with respect to the framework portion and the suspension member.

In the vehicle front structure according to the above aspect, at the time of small overlap collision between the vehicle and the collision body, the collision body that enters the vehicle rear side on the outer side of the framework portion in the vehicle width direction comes into contact with the protruding portion earlier than the framework portion and the suspension member. Since the collision load from the collision body is efficiently transmitted to the protruding portion, the efficiency of transmission of the collision load to the framework portion and the suspension member is improved. As a result, the vehicle can be rapidly and efficiently released from the collision body at the time of small overlap collision of the vehicle.

The vehicle front structure according to the first aspect includes:
a pair of suspension tower portions erected from upper surfaces of the framework portions, and integrated with the framework portions, the suspension tower portions being each provided on the side of the vehicle front portion in the vehicle width direction; and a suspension tower bar connecting the suspension tower portions in the vehicle width direction.

In the vehicle front structure according to the above aspect, at the time of small overlap collision between the vehicle and the collision body, the component force of the collision load to the inner side in the vehicle width direction is transmitted to one framework portion via the protruding portion and the joint portion. The component force of the collision load to the inner side in the vehicle width direction is transmitted to the other framework portion via the suspension towers and the suspension tower bar. Thus, the reaction force acting on the contact portion between the collision body and the protruding portion can be generated by the bending rigidity of the framework portions, the suspension towers, and the suspension tower bar in the vehicle width direction. By integrating the framework portion and the suspension tower portion, the efficiency of transmission of the collision load can be made higher than in the case where these are formed as separate components. Accordingly, the reaction force acting on the contact portion between the collision body and the protruding portion can be improved efficiently.

In the vehicle front structure according to the first aspect, the joint portion is integrated with the framework portion.

In the vehicle front structure according to the above aspect, the framework portion and the joint portion are integrated together. Therefore, it is possible to reduce the number of components at the joint portion between the framework portion and the suspension member, and to reduce the cost of the components.

In the vehicle front structure according to the first aspect, the protruding portion is integrated with the joint portion.

In the vehicle front structure according to the above aspect, the joint portion and the protruding portion are integrated together. Therefore, it is possible to reduce the number of components dedicated to the small overlap collision of the vehicle, and to reduce the cost of the components.

As described above, the vehicle front structure according to the present disclosure can efficiently release the vehicle from the collision body at the time of small overlap collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle front structure according to a first embodiment is applied as viewed from a left oblique front side, and is a perspective view schematically illustrating an example of a main portion of a vehicle front portion;

FIG. 2 is an exploded perspective view schematically illustrating an end portion of the framework portion on the vehicle front side according to the first embodiment;

FIG. 3 is a partial plan view schematically illustrating a state in which a part of a vehicle to which the vehicle front structure according to the first embodiment is applied is viewed from the vehicle upper side, and the right side of the vehicle is in a small overlap collision with the collision body;

FIG. 4 is a schematic view of the framework portion taken along line 4-4 of FIG. 3; and

FIG. 5 is an exploded perspective view schematically illustrating an end portion of the framework portion on the vehicle front side according to the second embodiment.

### DETAILED DESCRIPTION OF EMBODIMENTS

### First Embodiment

Hereinafter, the vehicle front structure 10 according to the first embodiment will be described with reference to the drawings. Note that an arrow FR appropriately shown in the drawings indicates a front side in the vehicle front-rear direction, and an arrow UP indicates an upper side in the vehicle up-down direction. The arrow LH indicates the left side in the vehicle width direction, and in the present embodiment, indicates the outer side in the vehicle width direction. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified.

Note that, unless otherwise specified in the specification, each element is not limited to one, and a plurality of elements may be present. In addition, in the drawings, substantially the same elements are denoted by the same reference numerals, and redundant description in the specification is omitted.

### Schematic Configuration of the Front Portion of the Vehicle

First, a vehicle 12 to which the vehicle front structure 10 according to the first embodiment is applied will be described. For example, the vehicles 12 are battery electric vehicle and fuel cell electric vehicle having power units including motors, engines, and the like as drive sources. Battery electric vehicle and fuel cell electric vehicle are driven by the power generated by the power unit.

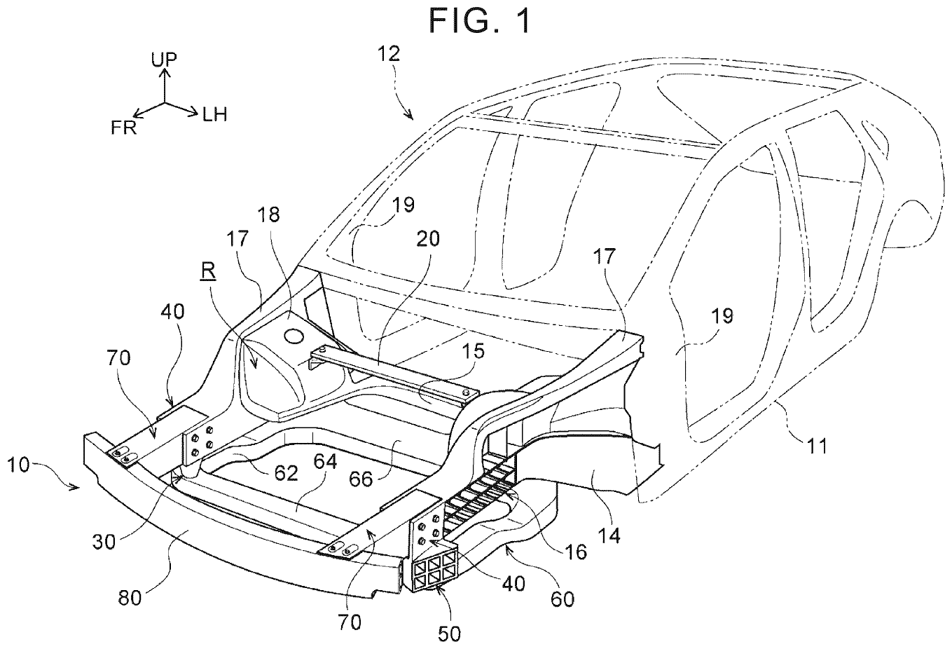

FIG. 1 is a perspective view of a vehicle 12 viewed from a left obliquely front side. FIG. 1 schematically shows a main part of a skeleton of a front part of a vehicle 12. As illustrated in FIG. 1, a front side member 16, a suspension member 60, a bumper reinforcement 80, and the like are provided at a front portion of the vehicle 12 as a framework portion of the vehicle 12.

The front side members 16 are provided on both side portions in the vehicle width direction in the vehicle front portion, and extend along the vehicle front-rear direction. A power unit (not shown) is disposed between the left and right front side members 16. The power unit is supported from the lower side by a suspension member 60. The suspension member 60 is disposed on the vehicle lower side of the left and right front side members 16. The front end portion and the rear end portion of the suspension member 60 are attached to the left and right front side members 16 from the lower side at both end portions in the vehicle width direction. Thus, the suspension member 60 is supported by the pair of left and right front side members 16 from the vehicle lower side.

A crash box 70 capable of absorbing impact energy with respect to an axial load extends from the front side member 16 toward the vehicle front side at an end portion of the left and right front side members 16 on the vehicle front side. A bumper reinforcement 80, which is a framework portion of the front bumper, extends along the vehicle width direction at the front ends of the left and right crash boxes 70.

Although the front side member 16 and the crash box 70 are described as separate components, they may be integrated.

On the other hand, a wheel house 14 in which wheels (not shown) are arranged is provided on the rear side of the left and right front side members 16. The right wheel house 14 and the left wheel house 14 are connected by a cross member 15.

Further, an apron upper member 17 is disposed on the outer side of the front side member 16 in the vehicle width direction and on the upper side in the vehicle up-down direction. The apron upper member 17 is a framework portion constituting a skeleton on the upper side in the front portion of the vehicle 12. The apron upper member 17 extends along the front side member 16 in the vehicle front-rear direction. The rear end portion of the apron upper member 17 is coupled to the front pillar 19. A suspension tower portion 18 is integrally formed with the apron upper member 17. On the rear side of the wheel house 14 in the vehicle front-rear direction, a rocker 11 extending along the vehicle front-rear direction and constituting the skeleton of the vehicle body side portion is provided.

In the present embodiment, the left and right front side members 16, the left and right wheel houses 14 and the cross members 15, the apron upper member 17, and the suspension tower portion 18 are integrally formed by casting using an aluminum alloy, a magnesium alloy, or the like as a material.

Therefore, each member of the front side member 16, the left and right wheel houses 14, the cross member 15, the apron upper member 17, and the suspension tower portion 18 has an open cross section that is opened in the die cutting direction during casting. Note that in the present embodiment, one and the other in the vehicle width direction can be the die cutting direction. Therefore, the cross section of each member is an open cross section that is open in at least one of the vehicle width directions.

All or part of the front side member 16, the left and right wheel houses 14, the cross member 15, the apron upper member 17, and the suspension tower portion 18 may be formed as separate components.

Hereinafter, the main components of the front side member 16, the suspension tower portion 18, the suspension member 60, and the bumper reinforcement 80 will be described in detail.

### Front Side Member

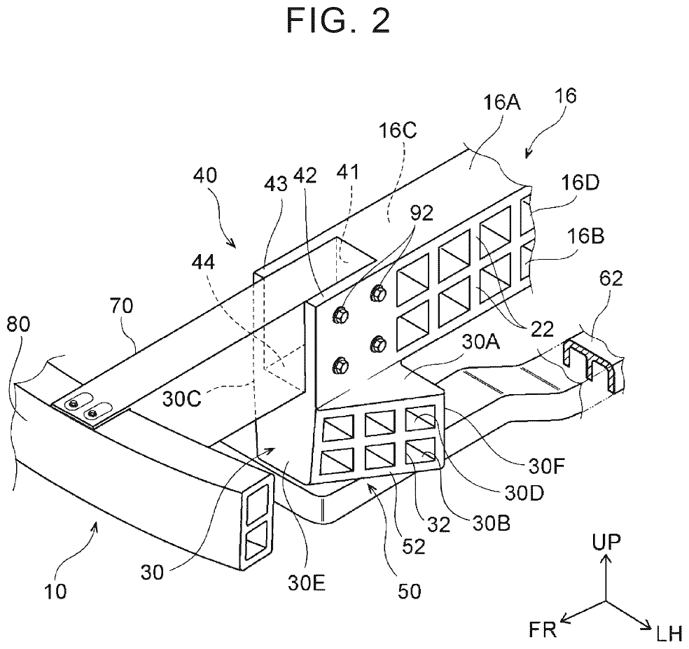

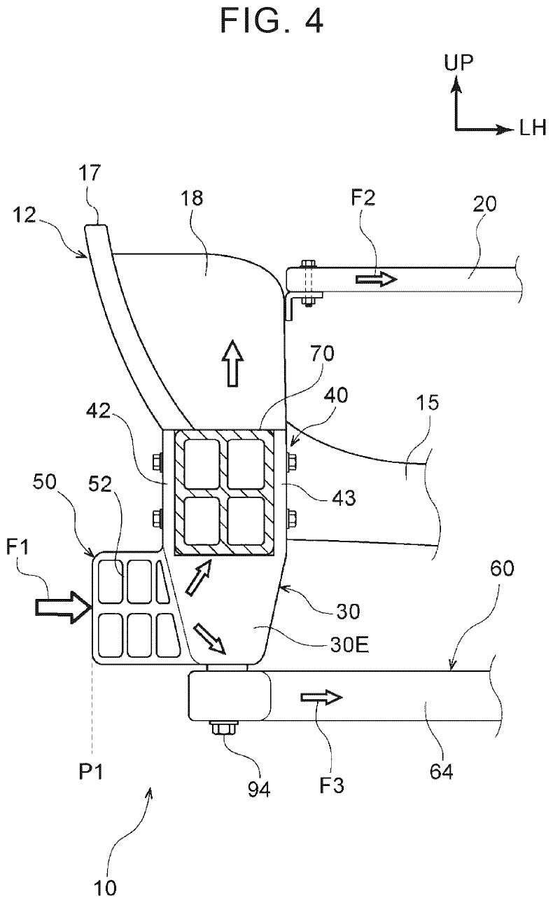

FIG. 2 is an exploded perspective view schematically illustrating an end portion of the front side member 16 on the vehicle front side. As shown in FIG. 2, the front side member 16 extends along the vehicle front-rear direction as described above. The front side member 16 includes an upper wall portion 16A, a lower wall portion 16B, an inner wall portion 16C (see FIG. 4), and a partition wall 16D. The front side member 16 has a substantially E-shaped open cross section that is open outward in the vehicle width direction. The upper wall portion 16A constitutes an upper wall of the front side member 16. The lower wall portion 16B constitutes a lower wall of the front side member 16. The inner wall portion 16C constitutes an inner wall connecting an inner end portion of the upper wall portion 16A in the vehicle width direction and an inner end portion of the lower wall portion 16B in the vehicle width direction. The partition wall 16D stands outward in the vehicle widthwise direction from an intermediate portion of the inner wall portion 16C in the vehicle vertical direction, and partitions the inner space of the front side member 16 into two rows in the vertical direction.

In the front side member 16, a plurality of ribs 22 are provided along the front-rear direction of the vehicle in the upper and lower rows separated by the partition wall 16D. As a result, the internal space of each column is partitioned into a plurality of rooms, and the open cross section of the front side member 16 is reinforced. When a collision load is input to the front side member 16 from the vehicle front side, a plurality of rooms formed in the upper and lower rows of the front side member 16 are sequentially destroyed from the vehicle front side. As a result, a breaking load is generated. In this process, the impact load is absorbed. In the front side member 16, the positions of the ribs 22 provided in the upper row and the ribs 22 provided in the lower row may coincide with each other in the vehicle front-rear direction or may be different from each other. From the viewpoint of reducing the load difference of the breaking load generated by the time difference by shifting the collapse timings of the ribs 22 in the upper and lower rows, the ribs 22 are preferably arranged as follows. That is, it is preferable that the ribs 22 provided in the upper row and the ribs 22 provided in the lower row are arranged so as to have different positions in the vehicle front-rear direction.

Further, a connecting portion 40 to which an end portion of the crash box 70 on the vehicle rear side is connected is formed at an end portion of the front side member 16 on the vehicle front side. The connecting portion 40 is a high-rigidity portion having higher rigidity than other regions of the front side member 16 by joining the front side member 16 and the crash box 70. Here, although the front side member 16 and the connecting portion 40 are integrally formed by casting, they may be configured separately.

The connecting portion 40 includes a first wall portion 41, a second wall portion 42, a third wall portion 43, and a fourth wall portion 44. The connecting portion 40 is open to the vehicle front side and the vehicle upper side. The first wall portion 41 has a main surface in which the vehicle front-rear direction is a plate thickness direction and faces the vehicle front-rear direction. An upper wall portion 16A, a lower wall portion 16B, an inner wall portion 16C, and a front end portion of the partition wall 16D of the front side member 16 are connected to the main surface constituting the rear surface of the first wall portion 41. On the other hand, an end portion of the crash box 70 on the vehicle rear side is connected to a main surface constituting the front surface of the first wall portion 41.

The second wall portion 42 is connected to an end portion of the first wall portion 41 on the outer side in the vehicle width direction, and extends toward the vehicle front side. The second wall portion 42 has a main surface that faces in the vehicle width direction, with the vehicle width direction being a plate thickness direction. The main surface of the second wall portion 42 on the inner side in the vehicle width direction is disposed so as to face the outer surface (not shown) of the crash box 70 on the outer side in the vehicle width direction. The second wall portion 42 is joined to the outer surface of the crash box 70 via the fastening member 92. The fastening member 92 is, for example, a weld nut welded to the inside of the crash box 70 and a bolt that penetrates the second wall portion 42 and the outer surface of the crash box 70 and is screwed to the weld nut.

The third wall portion 43 is connected to an end portion of the first wall portion 41 on the inner side in the vehicle width direction, and extends toward the vehicle front side. The third wall portion 43 has a main surface that faces in the vehicle width direction, with the vehicle width direction being a plate thickness direction. The main surface of the third wall portion 43 on the outer side in the vehicle width direction is disposed so as to face the inner side surface (not shown) on the inner side in the vehicle width direction of the crash box 70. Like the second wall portion 42, the third wall portion 43 is joined to the inner surface of the crash box 70 via the fastening member 92.

In this manner, in the crash box 70, both side portions in the vehicle width direction are joined to the end portion of the front side member 16 on the vehicle front side via the second wall portion 42 and the third wall portion 43 of the connecting portion 40. The crash box 70 and the front side member 16 may be joined by welding.

The fourth wall portion 44 of the connecting portion 40 is connected to an end portion of the first wall portion 41 on the vehicle lower side, and extends toward the vehicle front side. The fourth wall portion 44 has a main surface that faces the vehicle downward direction, with the vehicle vertical direction being the plate thickness direction. An end portion of the crash box 70 on the vehicle rear side is placed on the main surface constituting the upper surface of the fourth wall portion 44.

### Joint Portion

Here, a joint portion 30 for joining the front side member 16 and a suspension member 60 to be described later is provided on the lower surface of the fourth wall portion 44. The joint portion 30 is integrally formed on the lower surface of the fourth wall portion 44 and protrudes downward of the vehicle. In the present embodiment, the joint portion 30 is formed integrally with the front side member 16 (connecting portion 40) by casting. Therefore, the joint portion 30 has an open cross section that is open outward in the vehicle width direction.

Specifically, the joint portion 30 includes an upper wall portion 30A, a lower wall portion 30B, an inner wall portion 30C, a partition wall 30D, a front wall portion 30E, a rear wall portion 30F, and a rib 32, and has an open cross-section in a grid shape as viewed in the vehicle-width direction. The upper wall portion 30A constitutes an upper wall of the joint portion 30, and is integrated with the fourth wall portion 44 of the connecting portion 40 in the present embodiment. The lower wall portion 30B constitutes a lower wall of the joint portion 30. The inner wall portion 30C constitutes an inner wall connecting an inner end portion of the upper wall portion 30A in the vehicle width direction and an inner end portion of the lower wall portion 30B in the vehicle width direction. The partition wall 30D stands outward in the vehicle widthwise direction from an intermediate portion of the inner wall portion 30C in the vehicle up-down direction, and partitions the inner space of the joint portion 30 up and down. The front wall portion 30E constitutes a front wall connecting the upper wall portion 30A, the lower wall portion 30B, and the vehicle-front end portion of the partition wall 30D. The rear wall portion 30F constitutes a rear wall connecting the upper wall portion 30A, the lower wall portion 30B, and the vehicle-rear end portion of the partition wall 30D. The ribs 32 are provided in the space on the upper side and the space on the lower side separated by the partition wall 30D in the inner space of the joint portion 30.

The ribs 32 provided in the space above the partition wall 30D are formed across the upper wall portion 30A, the inner wall portion 30C, and the partition wall 30D. The ribs 32 provided in the space below the partition wall 30D are formed across the lower wall portion 30B, the inner wall portion 30C, and the partition wall 30D. In addition, a plurality of these ribs 32 are provided at intervals in the vehicle front-rear direction in the respective spaces on the upper side and the lower side. As a result, the open cross section of the joint portion 30 is reinforced.

Incidentally, from the viewpoint of integrally forming the front side member 16 and the joint portion 30 by casting, the joint portion 30 may have a configuration having an open cross section that is open in at least one of the vehicle width directions. Therefore, the joint portion may have an open cross section opened inward in the vehicle width direction, or may be opened on both sides in the vehicle width direction by omitting the inner wall portion 30C having the above-described configuration. Alternatively, although not illustrated, the joint portion 30 may have an open cross section that is open in at least one of the vehicle front-rear directions.

### Protruding Portion

Here, a protruding portion 50 protruding outward in the vehicle width direction from the joint portion 30 is provided at a portion of the joint portion 30 outside in the vehicle width direction. The protruding portion 50 is formed by extending an end portion of the joint portion 30 on the outer side in the vehicle width direction, and is formed integrally with the joint portion 30. In the present embodiment, the outer end portion of the joint portion 30 in the vehicle width direction is an outer end portion of the upper wall portion 30A, the lower wall portion 30B, the partition wall 30D, the front wall portion 30E, the rear wall portion 30F, and the rib 32 in the vehicle width direction.

The protruding portion 50 is formed in a substantially triangular shape having an end portion on the vehicle front side as a top portion in a plan view, and an inclined portion 52 inclined toward the vehicle rear side and the vehicle width direction outside is provided at an end portion on the vehicle width direction outside.

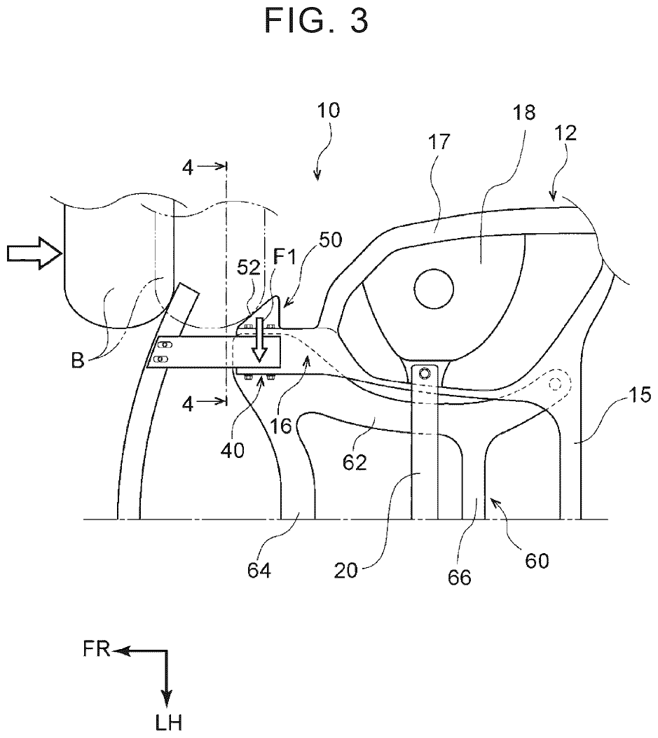

In the vehicle front structure 10 according to the present embodiment, in the region on the vehicle front side including the protruding portion 50, the end portion of the protruding portion 50 on the outside in the vehicle width direction is disposed outside the front side member 16 and the suspension member 60 in the vehicle width direction. This is illustrated in FIG. 3. Therefore, the collision load to the rear of the vehicle is promptly input to the inclined portion 52 of the protruding portion 50 at the time of the small overlap collision of the vehicle 12.

### Suspension Tower

As shown in FIGS. 1 and 3, the suspension tower portion 18 is erected from the upper surfaces of the pair of front side members 16. The suspension tower portion 18 is bridged between the front side member 16 and the apron upper member 17. The front side member 16, the apron upper member 17, and the suspension tower portion 18 are integrally formed. An upper end portion of a shock absorber of a suspension (not shown) is fixed to the suspension tower portion 18.

Here, a suspension tower bar 20 is bridged over the pair of suspension tower portions 18. The suspension tower bar 20 extends in the vehicle width direction, and an end portion in the vehicle width direction is fixed to an upper portion of the suspension tower portion 18 via a bracket or the like. Thus, the pair of suspension tower portions 18 is connected in the vehicle width direction by the suspension tower bar 20.

### Suspension Member

As shown in FIGS. 1 and 3, the suspension member 60 includes a pair of side rails 62 extending in the vehicle front-rear direction and spaced apart from each other in the vehicle width direction. The suspension member 60 includes a front cross member 64 that connects an end portion of the pair of side rails 62 on the vehicle front side in the vehicle width direction. In addition, the suspension member 60 includes a rear cross member 66 that connects parts of the pair of side rails 62 on the vehicle rear side in the vehicle width direction. As an example, the suspension member 60 includes a pair of side rails 62, a front cross member 64, and a rear cross member 66. Each of the pair of side rails 62, the front cross member 64, and the rear cross member 66 has a substantially E-shaped open cross section that is open to the vehicle lower side. Therefore, the suspension member 60 can be formed by casting using a mold having the vertical direction of the vehicle as the drawing direction. Note that it is not essential to integrally mold the suspension member 60.

The front end portion and the rear end portion of the suspension member 60 are attached to the front side member 16 at the end portion in the vehicle width direction. Here, the front end portion of the suspension member 60 is fixed to the front side member 16 via the joint portion 30. The front end portion of the suspension member 60 is an end portion of the pair of side rails 62 on the vehicle front side, and is an end portion of the front cross member 64 in the vehicle width direction.

The joint portion 30 and the suspension member 60 are joined by using the fastening member 94 (FIG. 4). The fastening member 94 is, for example, a bolt that penetrates the suspension member 60 and is screwed into a weld nut welded to the upper surface of the lower wall portion 30B of the joint portion 30. Here, although the joint portion 30 and the suspension member 60 are configured as separate components, the joint portion 30 and the suspension member 60 may be integrally formed by casting. That is, the front side member 16 and the suspension member 60 may be integrally formed.

### Bumper Reinforcement

The bumper reinforcement 80 is a hollow beam-shaped framework portion and extends along the vehicle width direction. The bumper reinforcement 80 is connected in a state in which an end portion on the outside in the vehicle width direction protrudes outward in the vehicle width direction beyond an end portion on the vehicle front side of the crash box 70. In addition, the bumper reinforcement 80 is gently curved such that an intermediate portion in the vehicle width direction is convex toward the vehicle front side in a plan view.

### Action and Effect

As described above, in the vehicle front structure according to the first embodiment, the protruding portion 50 is provided in the joint portion 30. The joint portion 30 joins the pair of front side members 16 and the suspension members 60 disposed on the vehicle lower side of the front side members 16. The protruding portion 50 protrudes outward in the vehicle width direction from the joint portion 30.

Here, FIG. 3 is a partial plan view schematically showing a state in which the right side portion of the vehicle 12 is in a small overlap collision with the collision body B. FIG. 4 is a view schematically illustrating a state in which the framework portion is cut along line 4-4 of FIG. 3. As shown in FIG. 4, when the vehicle 12 collides with the collision body by small overlap collision, a collision load mainly toward the rear of the vehicle is input to the protruding portion 50. Then, the component force F1 of the impact load to the vehicle-width-direction inner side is efficiently distributed to the front side member 16 and the suspension member 60 via the joint portion 30.

Specifically, when the vehicle collides with the collision body at small overlap collision, a part of the component force F1 on the vehicle widthwise inner side of the collision load is transmitted to one of the front side members 16 via the protruding portion 50 and the joint portion 30 (arrow F2). The component force F2 is transmitted to the other front side member 16 via the pair of suspension tower portions 18 and the suspension tower bar 20.

On the other hand, when the vehicle makes a small overlap collision with the collision body, a part of the component force F1 on the vehicle widthwise inner side of the collision load is transmitted to the suspension member 60 via the protruding portion 50 and the joint portion 30 (arrow F3).

As a result, the reaction force generated at the contact portion between the collision body B and the protruding portion 50 is generated by at least the bending rigidity of the front side member 16 and the suspension member 60 in the vehicle width direction. Accordingly, the reaction force acting on the contact portion can be improved, and the vehicle 12 can be efficiently released from the collision body B at the time of the small overlap collision of the vehicle.

Further, in the present embodiment, an inclined portion 52 inclined toward the vehicle rear side and the vehicle width direction outer side in a plan view is provided at an end portion of the protruding portion 50 on the vehicle width direction outer side. Therefore, when the vehicle 12 collides with the collision body B by small overlap collision, the collision load mainly toward the rear of the vehicle can be changed to the lateral force toward the inside in the vehicle width direction. Accordingly, it is possible to efficiently transmit the component force F1 of the impact load to the vehicle-width-direction inner side to the front side member 16 and the suspension member 60.

Further, in the present embodiment, in the region on the vehicle front side including the protruding portion 50, the end portion of the protruding portion 50 on the outer side in the vehicle width direction is disposed on the outer side in the vehicle width direction than the front side member 16 and the suspension member 60. Note that FIG. 4 shows the position P1 of the vehicle-width-direction-outer end portion of the protruding portion 50 in a plan view. Therefore, when the vehicle 12 makes a small overlap collision with the collision body B, the collision body B that enters the vehicle rear side outside the front side member 16 in the vehicle width direction comes into contact with the protruding portion 50 before the front side member 16 and the suspension member 60. See the two-dot chain line position of the impactor in FIG. 3 for the manner of abutment. Accordingly, since the collision load from the collision body is efficiently transmitted to the protruding portion 50, the transmission efficiency of the collision load to the front side member 16 and the suspension member 60 is improved. As a result, the vehicle 12 can quickly and efficiently escape from the collision body B at the time of a small overlap collision of the vehicle.

In the present embodiment, a pair of suspension tower portions 18 and a suspension tower bar 20 are provided. The pair of suspension tower portions 18 are erected from the upper surfaces of the pair of front side members 16 and are integrally formed with the front side members 16. The suspension tower bar 20 connects the pair of suspension tower portions 18 in the vehicle width direction. Therefore, the reaction force acting on the contact portion between the collision body B and the protruding portion 50 can be generated by the bending rigidity of the pair of front side members 16, the pair of suspension tower portions 18, and the suspension tower bar 20 in the vehicle width direction. Further, by integrally forming the front side member 16 and the suspension tower portion 18, it is possible to increase the transmission efficiency of the collision load as compared with the case where these are formed as separate parts. Accordingly, the reaction force acting on the contact portion between the collision body B and the protruding portion 50 can be efficiently improved.

Further, in the present embodiment, the front side member 16 and the joint portion 30 are integrally formed. Therefore, it is possible to reduce the number of parts at the joining point between the front side member 16 and the suspension member 60, and to reduce the cost of the parts.

Further, in the present embodiment, the joint portion 30 and the protruding portion 50 are integrally formed. Therefore, it is possible to reduce the number of components of the dedicated component corresponding to the small overlap collision of the vehicle, and it is possible to reduce the cost of the components.

### Second Embodiment

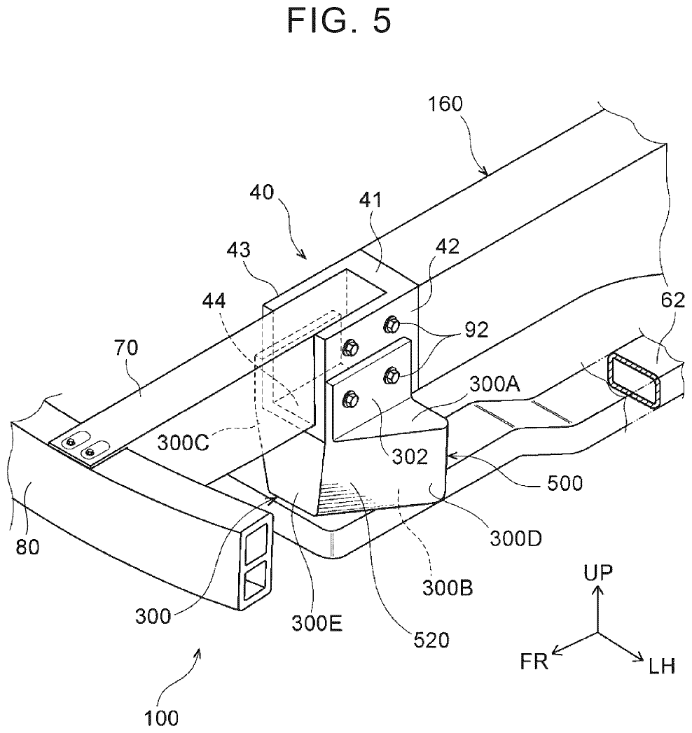

Hereinafter, the vehicle front structure 100 according to the second embodiment will be described with reference to FIG. 5. The same components as those in the first embodiment described above are denoted by the same reference signs and the description thereof will be omitted. As shown in FIG. 5, in the vehicle front structure according to the second embodiment, the pair of front side members 160, the connecting portion 40, and the joint portion 300 are formed separately. Other configurations are the same as those of the vehicle front structure 10 according to the first embodiment.

The front side members 160 are provided on both side portions in the vehicle width direction in the vehicle front portion, and extend along the vehicle front-rear direction. The front side member 160 has a closed cross-sectional structure, and is formed by overlapping the upper member and the lower member. As described above, in the present disclosure, it is not essential that the front side member as the framework portion has an open cross section.

A connecting portion 40 formed separately is joined to an end portion of the front side member 160 on the vehicle front side by welding or the like. Further, a joint portion 300 formed separately from the connecting portion 40 is provided on the lower side of the connecting portion 40.

The joint portion 300 includes, for example, an upper wall portion 300A, a lower wall portion 300B, an inner wall portion 300C, an outer wall portion 300D, and a front wall portion 300E, and has an open cross section open toward the rear of the vehicle. The upper wall portion 300A constitutes an upper wall of the joint portion 300, and has a pair of vertical wall portions 302 erected upward from the upper surface. The connecting portion 40 is inserted between the pair of vertical wall portions 302. The pair of vertical wall portions 302 are fastened together with the crash box 70 to the second wall portion 42 or the third wall portion 43 of the connecting portion 40 using the fastening member 92.

The lower wall portion 300B constitutes the lower wall of the joint portion 300, and is joined to the front end portion of the suspension member 60 and the vehicle-width-direction outer end portion by fastening or the like. The inner wall portion 300C connects an inner end portion of the upper wall portion 300A in the vehicle width direction to an inner end portion of the lower wall portion 300B in the vehicle width direction. The outer wall portion 300D connects an outer end portion of the upper wall portion 300A in the vehicle width direction and an outer end portion of the lower wall portion 300B in the vehicle width direction. Further, the front wall portion 300E connects the vehicle front side end portion of the upper wall portion 300A and the vehicle front side end portion of the lower wall portion 300B.

Here, the outer wall portion 300D is inclined obliquely toward the vehicle rear side and the vehicle widthwise outer side in a plan view. As a result, the protruding portion 500 protruding outward in the vehicle width direction from the joint portion 300 is formed by the portion of the upper wall portion 300A and the lower wall portion 300B on the outer side in the vehicle width direction and the outer wall portion 300D. Therefore, in the present embodiment, the inclined portion 520 provided at the vehicle-width-direction outer end portion of the protruding portion 500 is formed of a flat surface by the outer wall portion 300D.

Here, the joint portion 300 and the protruding portion 500 are integrally formed, but the joint portion 300 and the protruding portion 500 may be formed separately and then joined by welding or the like.

### Action and Effect

Since the vehicle front structure 100 having the above-described configuration basically follows the configuration of the vehicle front structure 10 according to the first embodiment, the same operation and effects can be obtained. In the present embodiment, the inclined portion 520 (the outer wall portion 300D) of the protruding portion 500 is formed of a flat surface. Therefore, the contact area between the collision body B and the protruding portion 500 increases, and the input direction of the collision load can be stabilized.

Although the embodiments of the vehicle front structure according to the present disclosure have been described above, the present disclosure is not limited thereto. For example, the joint portion according to the present disclosure may be formed integrally with the front end portion of the suspension member and the end portion in the vehicle width direction.

What is claimed is:

1. A vehicle front structure comprising:
a pair of framework portions extending in a vehicle front-rear direction, the framework portions being each provided on a side of a vehicle front portion in a vehicle width direction;
a suspension member disposed on a vehicle lower side of the framework portions;
a joint portion that joins the framework portion and the suspension member; and
a protruding portion provided at the joint portion and protruding to an outer side in the vehicle width direction.

2. The vehicle front structure according to claim 1, wherein an inclined portion that is inclined to a vehicle rear side and the outer side in the vehicle width direction in a plan view is provided at an end of the protruding portion on the outer side in the vehicle width direction.

3. The vehicle front structure according to claim 1, wherein in a region on a vehicle front side including the protruding portion, the end of the protruding portion on the outer side in the vehicle width direction is positioned on the outer side in the vehicle width direction with respect to the framework portion and the suspension member.

4. The vehicle front structure according to claim 1, further comprising:
a pair of suspension tower portions erected from upper surfaces of the framework portions, and integrated with the framework portions, the suspension tower portions being each provided on the side of the vehicle front portion in the vehicle width direction; and
a suspension tower bar connecting the suspension tower portions in the vehicle width direction.

5. The vehicle front structure according to claim 1, wherein the joint portion is integrated with the framework portion.

6. The vehicle front structure according to claim 1, wherein the protruding portion is integrated with the joint portion.
